(19) United States
(12) Patent Application Publication
(10) Pub. No.: US 2020/0112840 A1
(43) Pub. Date: Apr. 9, 2020

(54) Zip Ad

(71) Applicant: Edward L. Russell, JR., Ellenwood, GA (US)

(72) Inventor: Edward L. Russell, JR., Ellenwood, GA (US)

(21) Appl. No.: 16/153,740

(22) Filed: Oct. 6, 2018

(51) Int. Cl. H04W 4/23; G06Q 30/02; G06F 17/30

(52) U.S. Cl. CPC H04W 4/23; G06F 17/30879; G06Q 30/0257

(57) ABSTRACT

A self-contained unit in a form of a App. That is able to capture and send the product and customer Information to the seller of that product by the way of an electronic instrument

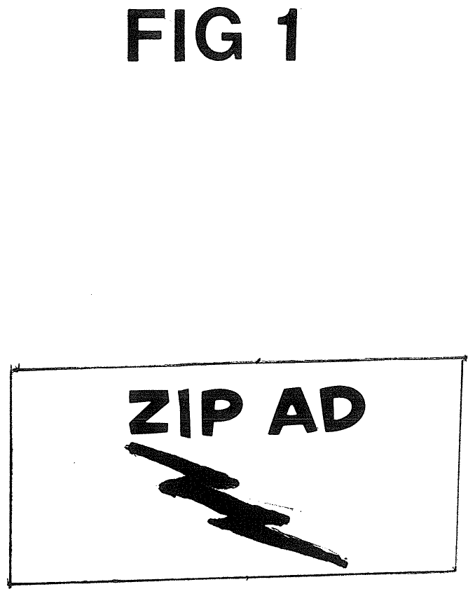

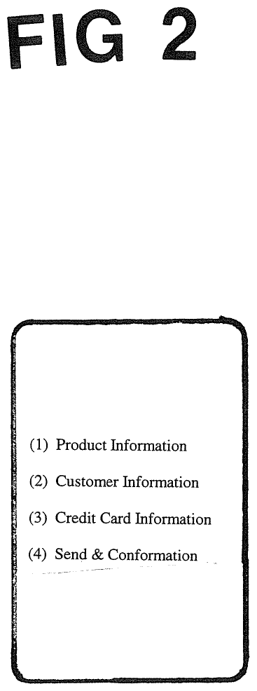

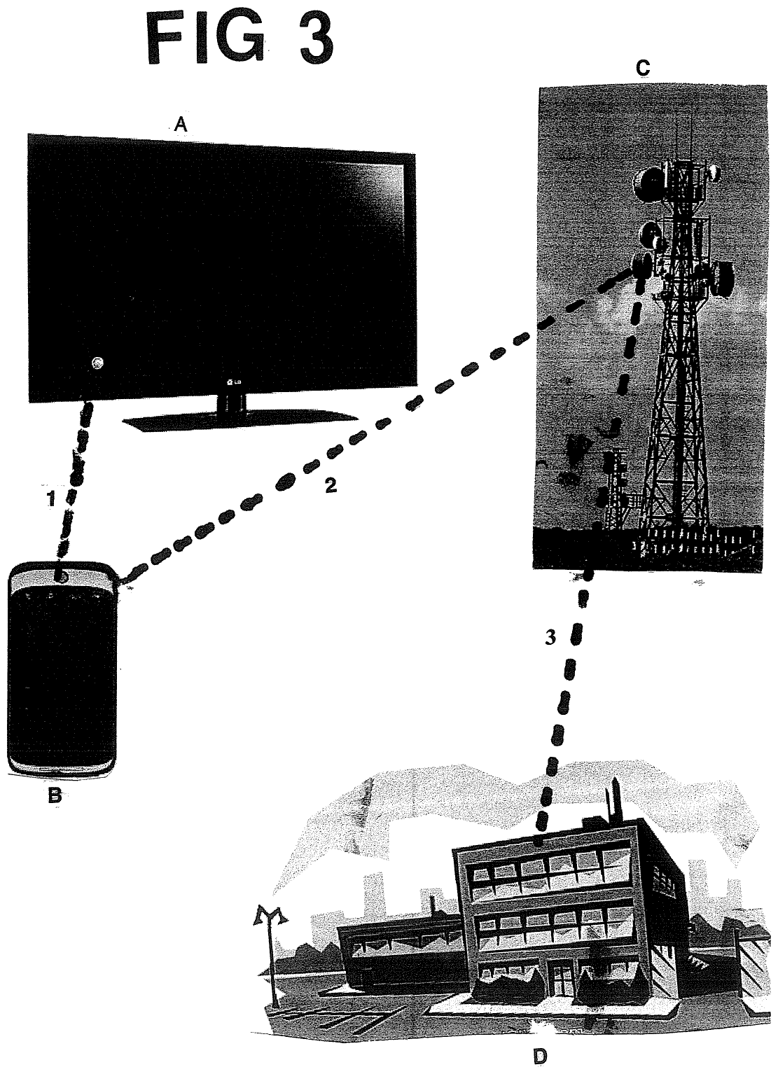

### FIELD OF INVENTION

This invention relates to advertisement, specifically to the improvement and cost effectiveness of advertising on the television. The system is a unit consisting of an app that captures the advertisement on the television, attaches personal information to it. And then the information is sent to a Cell Phone Tower which in turns sends the information to the proper Call Center for processing and distribution of the product and or information requested.

### PRIMARY COMPONENTS

(1) A TELEVISON

(2) A Electronic Instrument

(3) A Land Base Cell Phone Tower

(4) Distribution Center

### PATENTS

U.S. Pat. No. 9,990,620

U.S. Pat. No. 8,326,770

U.S. Pat. No. 8,396,808

2002/0123938

2003/0229678

2007/0011104

2007/0203836

2007/0108269

2009/0119190

2010/01147433

2010/0138344

2011/0029416

2001/0320347

2012/0041879

2012/0089461

2012/0150728

2012/0197794

### DESCRIPTION OF PRIOR ART

In 1990 advertising estimated expenditures by medium was a staggering 129,590,000,000 of this Those who made the decision to advertise nationally spent a recorded 73,380,000,000 those who decided to concentrate on the local market spent 56,210,000,000. According to Statistical Abstract Of the U.S. 2001. In 2000 the national advertising expenditure rose to the height of 236,332,000,000 with national coverage being 142,742,000,000 and local coverage 93,590,000,000. In 1990 of the 129,590,000,000 spent on advertising, broadcasting television spent 26,616,000,000. When the advertising expenditure grew to the record 236,332,000,000 television advertising tagged right along spending 44,438,000,000. The big four accounted for 15,706,000,000 of this spending. Advertising on syndicated shows 3,126,000,000 was spent. National spots were even higher with 13,631,000,000 Cable television brought in another 12,364,000,000. With cable television, national spots were 9,000,000,000 and local spots were 3,364,000,000. From a company with a one operation, to a Fortune 500 Company, advertising plays an important role in the future success of the company. With the average rate on return spent on advertisement dollar at 3% to 5%. This leaves very little room for error.

### SUMMARY OF INVENTION

Robert G Allen well known and successful author and entrepreneur, among best sellers books including spots.

Super-Bowl in January each year. In 60 seconds, $1 million dollars evaporates into thin air.

There is no mechanism for fast, easy follow-up contact with any of the potential customers. These advertisers Just lay down their million bucks with the hope that someone notices. Do you think that the company who Bought those million-dollar Super-Bowl spots would be interested in having the names and addresses of all the people who watched the ad and were interested in the product, Absolutely! The company could then focus all of its advertising budget on these few highly qualified prospects and quit wasting money on uninterested or unqualified viewers like the other 500 million people who watched the Super-Bowl.” This is what Zip Ad does The concept of Zip Ad system is a self-contained app. The system is used to capture the product or service information on an electronic instrument by the way of a bar code. The information is processed than sent to the prospected person or company.

Free or discounts can be sent strait to your e-mail address immediately or by mail if you have on computer. In 2000 direct mail advertising cost were 44,715,000,000 according to the Statistical Abstract of United States. Zip AD turns a 3% to 5% rate of returns to a 100% response rate. The appealing features of Zip Ad is that it is self contained, easy to program, easy to use, and you get a quick response.

### BRIEF DESCRIPTION OF THE DRAWING

FIG. (1) Looking at the Zip Ad App.

FIG. (2) Looking at the Product information screen

FIG. (3) Looking at the Zip Ad App. Processing System.
(A) Flat Screen TV
(1) Represents the signal capture from a electronic Instrument.
(B) Cell Phone
(2) Represents the signal transfer To Cell Tower
(C) Cell Phone Tower
(3) Represents signal transfer to Seller
(D) Building of seller or service.

### DESCRIPTION OF PREFERRED EMBODIMENTS

FIG. (3A) Looking at what is called a vertical look at an electronic instrument that has a product or service for sale to the public by way of a commercial. The seller provides bar code that contains the information.

(3-1) Looking at what is called a vertical look at what represents a signal taken from the electronic instrument In the way a picture from a cell phone.

(3-B) Looking at a what is called a vertical at a electronic instrument call a cell phone. This instrument captures the information from a bar code The process begins to collect product, customer, payment information on a secured system. The final process is a send and conformation code.

(3-2) Looking at what represents a signal sent from a electronic instrument called a cell phone to a cell tower.

(3-C) Looking at what's called a vertical look at what is called a Cell Phone Tower. This instrument receives a signal from a cell phone and transfers it to the proper location

(3-3) Looking at what represents a signal from what is call a cell phone tower to what is called the destination

(3-D) Looking at what is called the final destination. What also be refer to as Call Center, Home, Business for final processing.

What is claimed is:

1. A system for monitoring information on licenced person and/or a legal registration of a motor vehicle driving on the road comprising; an orbiting satellite, an electronic registration tag being attached to a motor vehicle license plate, and communication means to communicate between said orbiting satellite and said electronic registration tag for illuminating said vehicle license plate only when the person and or the vehicle registration being determined proper or valid.

2. According to claim 1 activation occurs when information from person or persons vehicle is link to code number.

3. According to claim 1 said code number is then transmitted and linked to an orbiting satellite

4. According to claim 1 after said number is received it builds a firewall around the code number and the information is processed, the satellite switches into transmission mode that is in its data bank.

5. According to claim 1 the orbiting satellite transmits own wave back to earth in search of matching code that is in its data bank.

6. According to claim 1 with-in seconds after the satellite transmission the code number is linked to the proper registration tag.

7. According to claim 1 activation is confirmed by the illuminated registration tag that is on the license plate.

8. According to claim 1 the registration tag consist of a transmitter and reciever especially made to receive the code wave from the satellite.

9. According to claim 1 the A.T.O.R units shell or covering is a sealed unit and is attached to a states, or nations license plate. With a common fasteners.
